(19) United States
(12) Patent Application Publication
(10) Pub. No.: US 2015/0168997 A1
(43) Pub. Date: Jun. 18, 2015

(54) SWITCH STRUCTURE

(71) Applicant: DENSO CORPORATION, Kariya-city, Aichi-pref. (JP)

(72) Inventors: Kimihiro Matsuoka, Kasugai-city (JP); Hiroshi Mokudai, Nagoya-city (JP)

(21) Appl. No.: 14/403,533

(22) PCT Filed: May 13, 2013
(86) PCT No.: PCT/JP2013/003035

§ 371 Date: Nov. 24, 2014

(30) Foreign Application Priority Data
May 28, 2012 (JP) 2012-121116

(51) Int. Cl. G06F 1/16; G06F 3/041; G06F 3/044

(52) U.S. Cl. CPC G06F 1/169; G06F 3/044; G06F 3/0412

(57) ABSTRACT

A switch structure provided to an electronic device including a display screen and a frame body includes an input panel, a detector, and a holding portion. The input panel is formed separately from the frame body and installed along an outer edge of the display screen and has an input plane via which an operation on the electronic device is inputted and a back surface on an opposite side to the input plane. The detector is attached to the back surface of the input panel and detects an input to the input plane. The holding portion is formed of the frame body and holds the input panel.

### CROSS REFERENCE TO RELATED APPLICATION

The present disclosure is based on Japanese Patent Application No. 2012-121116 filed on May 28, 2012, the disclosures of which are incorporated herein by reference.

### TECHNICAL FIELD

The present disclosure relates to a switch structure provided to an electronic device and having an input plane via which an operation on the electronic device is inputted.

### BACKGROUND ART

Conventionally, an electronic device including a display screen displaying an image and a frame-shaped design panel enclosing the display screen is known as a vehicle operation input device disclosed, for example, in PTL 1. In such an electronic device including the display screen, a switch operation plane to which an operation on the device is inputted is installed to the design panel in a region along an outer edge of the display screen. An input to the switch operation plane is detected by a touch sensor, such as transparent electrodes, attached to a back surface of the design panel on the opposite side to the switch operation plane.

### CITATION LIST

### Patent Literature

PTL 1: JP-A-2011-251647

### SUMMARY OF INVENTION

### Technical Problem

A demand is increasing for the conventional electronic device to improve designability of the input plane, which corresponds to the switch operation plane of PTL 1, by adding decoration, such as by forming the plane in a three-dimensional shape and providing a plated portion. However, as is disclosed in PTL 1, the design panel is a member enclosing the display screen and is therefore easily increased in size. Moreover, the design panel often takes a complex shape due to ribs used to ensure rigidity. When the input plane is provided to such a design panel, working to add decoration becomes difficult and a design on the input plane is limited. Hence, it is difficult to improve designability of the input plane. Further, it is also difficult to achieve satisfactory workability of a work to attach a detector, such as a touch sensor, to the back surface of the design panel of a large size and a complex shape.

The present disclosure was devised in view of the problems discussed above and has an object to provide a switch structure capable of improving not only designability of an input plane but also workability of detector attachment.

### Solution to Problem

A switch structure according to one aspect of the present disclosure is provided to an electronic device including a display screen displaying an image and a frame-shaped frame body enclosing the display screen. The switch structure includes an input panel, a detector, and a holding portion. The input panel is formed separately from the frame body and installed along an outer edge of the display screen and has an input plane via which an operation on the electronic device is inputted and a back surface on an opposite side to the input plane. The detector is attached to the back surface of the input panel and detects an input to the input plane. The holding portion is formed of the frame body and holds the input panel.

According to the switch structure above, the input plane is provided to the input panel, which is a separate body from the frame body. Hence, not only designability of the input plane but also workability of detector attachment can be improved.

### BRIEF DESCRIPTION OF DRAWINGS

The above and other objects, features and advantages of the present disclosure will become more apparent from the following detailed description made with reference to the accompanying drawings. In the drawings:

FIG. 1 is a perspective view of a navigation device provided with a switch structure according to one embodiment of the present disclosure;

FIG. 2 is a front view of the navigation device;

FIG. 3 is a view used to describe configurations of an ornament and an electrostatic sheet switch provided to the switch structure according to one embodiment of the present disclosure;

FIG. 4 is a plan view used to describe a configuration of the electrostatic sheet switch;

FIG. 5 is a view used to describe an electrostatic sheet attachment step;

FIG. 6 is a view used to describe an ornament attachment step; and

FIG. 7 is a view used to describe a connector connection step.

### DESCRIPTION OF EMBODIMENTS

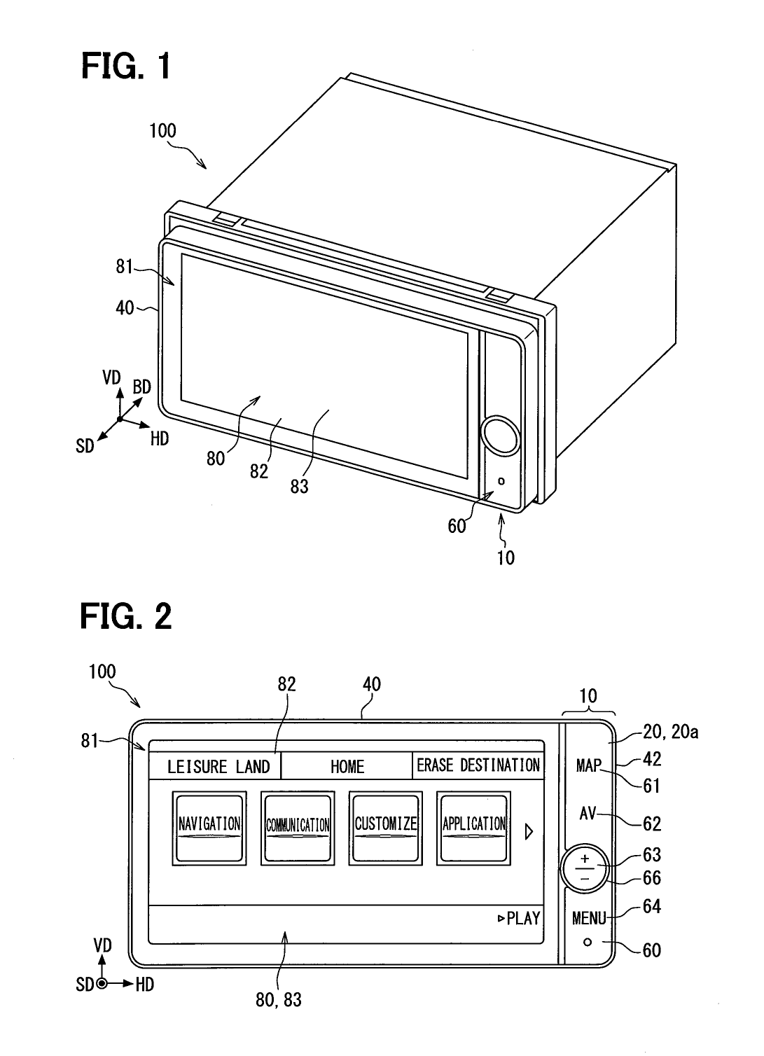

Hereinafter, one embodiment of the present disclosure will be described according to the drawings. A switch structure 10 according to one embodiment of the present disclosure is provided to a navigation device 100 shown in FIGS. 1 and 2. The navigation device 100 includes a display screen 80 formed integrally with a touch panel 82, and an input plane 60. The navigation device 100 provides a guidance on a route to a destination determined by operations inputted into the touch panel 82 and the input plane 60 using a map image or the like displayed on the display screen 80. The navigation device 100 is stored in a center console of a vehicle while the display screen 80 and the input plane 60 are exposed toward a driver seat. Hereinafter, a direction in which the display screen 80 is oriented is defined as a display direction SD and an inverse direction to the display direction is defined as a back surface direction BD for ease of description. In addition, a longitudinal direction of the display screen 80 is defined as a horizontal direction HD and a direction orthogonal to the horizontal direction along the display screen 80 is defined as a vertical direction VD.

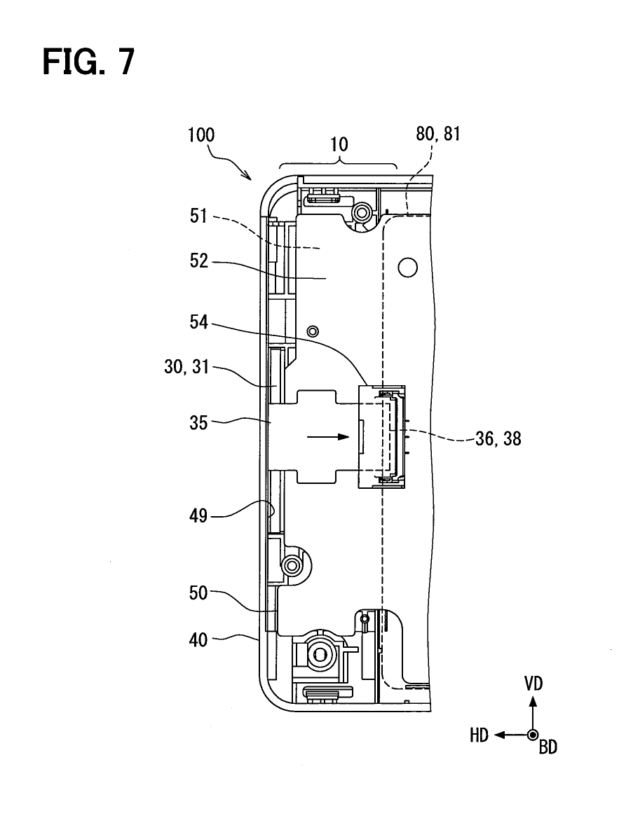

As are shown in FIGS. 2 and 7, the navigation device 100 is formed of a liquid crystal display instrument 81, an escutcheon 40, a circuit board 50, the switch structure 10 described above, and so on. The liquid crystal display instrument 81 includes a liquid crystal display 83 and the touch panel 82 that together form the display screen 80 shown in FIG. 2.

The liquid crystal display 83 is of a dot matrix type that realizes a color display by controlling a plurality of pixels arrayed in the display screen 80. The liquid crystal display 83 displays a map image or the like relating to a route guidance and drawn by a drawing circuit equipped to the navigation device 100 on the display screen 80. The display screen 80 is of a horizontally long shape that is longer in the horizontal direction HD than in the vertical direction VD.

The touch panel 82 is installed along the display screen 80 in the display direction SD of the display screen 80 and formed in the shape of a plate from a translucent material to transmit light emitted from the display screen 80. The touch panel 82 detects a position of an operation body, such as a finger, brought in close proximity to or in contact with the display screen 80 by a driver or the like as an operator.

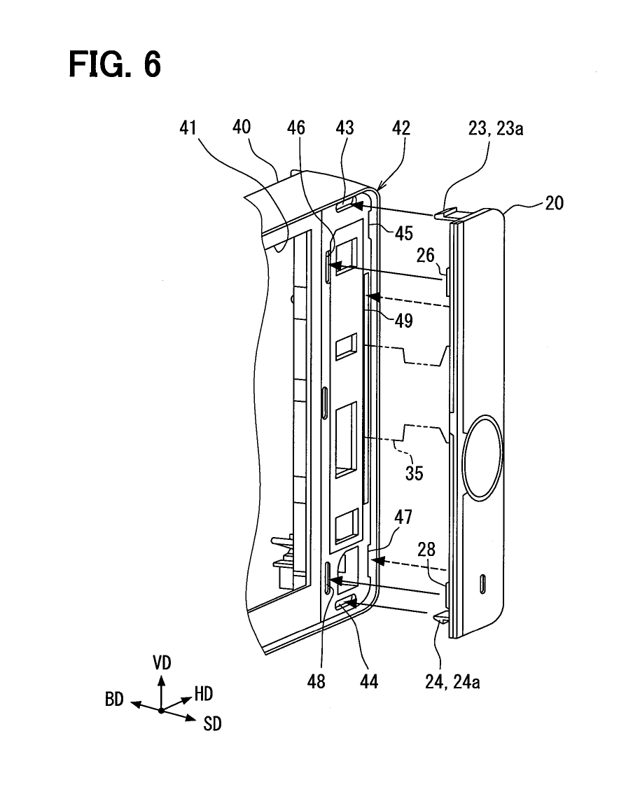

The escutcheon 40 is made of a resin material or the like and serves as a member of a rectangular frame shape enclosing the display screen 80. The escutcheon 40 is provided with an opening 41 (see FIG. 6) corresponding to an outer shape of the liquid crystal display instrument 81. The escutcheon 40 is externally fit to the liquid crystal display instrument 81 and thereby stores the liquid crystal display instrument 81 in the opening 41.

The circuit board 50 shown in FIG. 7 is installed in the back surface direction BD of the liquid crystal display instrument 81. The circuit board 50 is held by the escutcheon 40 in a posture in which a plate surface direction thereof is aligned along the display screen 80. Of the both surfaces of the circuit board 50, a plurality of micro-computers and electronic parts forming the drawing circuit, a control circuit, and so on of the navigation device 100 (see FIG. 1) are mounted on a counter surface 51 located in the display direction SD (see FIG. 1). On the other hand, of the both surfaces of the circuit board 50, a connector 54 connected to an electrostatic sheet switch 30 described below is mounted on a rear surface 52 located in the back surface direction.

The switch structure 10 shown in FIGS. 2, 3, and 6 has the input plane 60 described above via which the driver or the like inputs an operation on the navigation device 100, and is formed of an ornament 20, the electrostatic sheet switch 30, a holding portion 42 provided to the escutcheon 40, and so on.

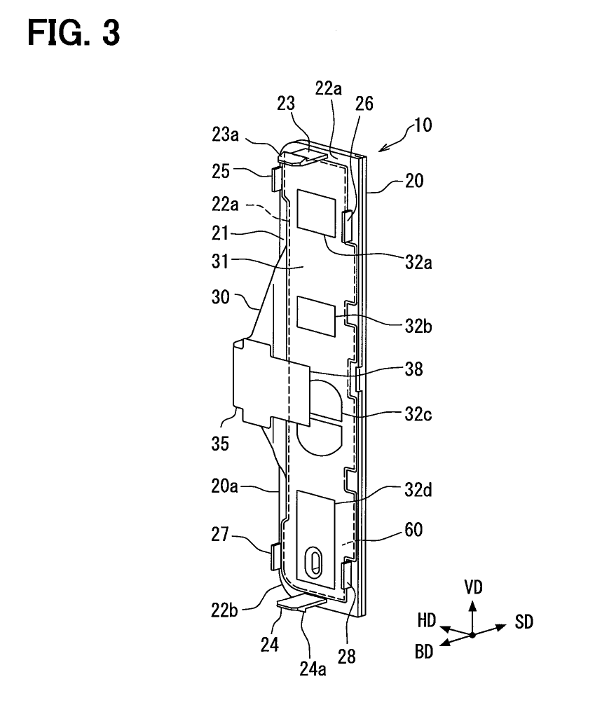

The ornament 20 shown in FIGS. 2 and 3 is made of a resin material or the like and formed separately from the escutcheon 40. The ornament 20 is fit together with the escutcheon 40 so as to lie along one of the two outer edges of the display screen 80 in the vertical direction VD whichever is the closer to the driver seat. The ornament 20 has an ornament main body portion 20a, a plurality of locking claws 23 and 24, and a plurality of ribs 25 through 28.

The ornament main body portion 20a shown in FIG. 2 is shaped like a rectangular plate. Of both surfaces of the ornament main body portion 20a, the input plane 60 is formed on one surface located in the display direction SD in a longitudinal shape along the outer edge of the display screen 80. The input plane 60 is provided with a plurality of switch plane portions 61 through 64, a decorative plated portion 66, and so on. The plurality of switch plane portions 61 through 64 are aligned along the vertical direction VD of the display screen 80. The respective switch plane portions 61 through 64 transmit light and display a design by emitting light. For ease of description, numerals 61 through 64 are sequentially assigned to the switch plane portions from top to bottom in the vertical direction VD. The respective switch plane portions 61 through 64 are formed so as to be located on substantially a same plane as the touch panel 82. The decorative plated portion 66 is provided in a part of the input plane 60 by forming a metal thin film by plating or the like. The decorative plated portion 66 is of an annular shape surrounding the periphery of the switch plane portion 63 formed in a circular shape.

As is shown in FIG. 3, a back surface 21 of the ornament main body portion 20a on the opposite side to the input surface 60 is provided with attachment region 22a to which the electrostatic sheet switch 30 is attached and an enclosure region 22b that encloses the attachment region 22a and faces the attachment region 22a. The attachment region 22a is located in the back surface direction BD of the respective switch plane portions 61 through 64 (see FIG. 2). When the electrostatic sheet switch 30 is attached to the attachment region 22a, the enclosure region 22b faces the outer edges of the switch 30 and is aligned along the outer edges.

The respective locking claws 23 and 24 are provided to stand substantially upright toward the holding portion 42 (see FIG. 6) in the back surface direction BD from both end portions of the enclosure region 22b in the longitudinal direction of the ornament main body portion 20a. Convex portions 23a and 24a protrude, respectively, from tip ends of the locking claws 23 and 24 in the standing direction. The convex portions 23a and 24a protrude on the outer peripheral side of the attachment region 22a along a direction crossing the standing direction. Wall surfaces of the respective locking claws 23 and 24 facing the inner peripheral side of the enclosure region 22b are configured so as to lie along the outer edges of the electrostatic sheet switch 30 by extending in the horizontal direction HD.

The respective ribs 25 through 28 are provided to stand substantially upright in the back surface direction BD from the enclosure region 22b. The respective ribs 25 through 28 are provided to extend in the vertical direction VD and are therefore configured so as to lie along the outer edges of the electrostatic sheet switch 30. The respective ribs 25 and 26 are located in closer proximity to the locking claw 23 than to a center of the ornament main body portion 20a in the vertical direction VD. The ribs 25 and 26 are slightly displaced with respect to each other in the vertical direction VD. On the other hand, the respective ribs 27 and 28 are located in closer proximity to the locking claw 24 than to the center of the ornament main body portion 20a in the vertical direction VD. The ribs 27 and 28 oppose each other in the horizontal direction HD.

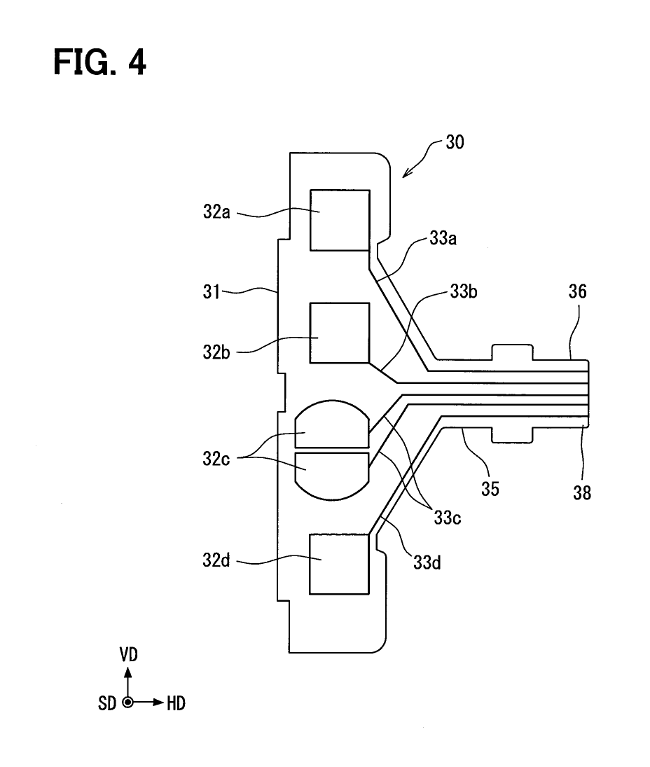

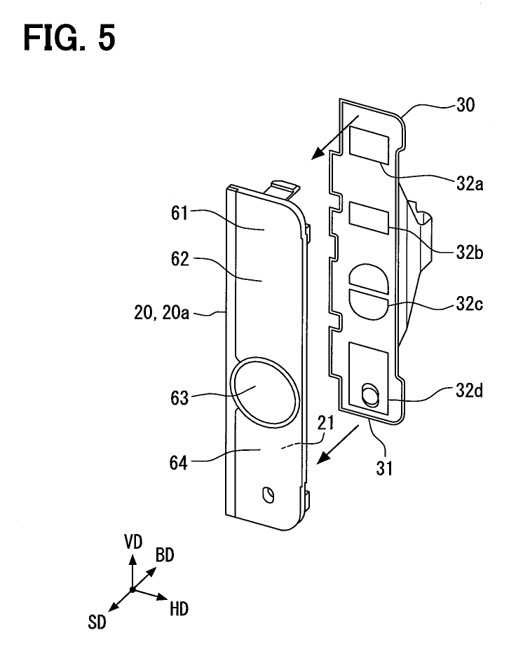

The electrostatic sheet switch 30 shown in FIGS. 3 and 4 is formed of a sheet-like flexible substrate with flexibility, and located between the ornament 20 and the circuit board 50 (see FIG. 7). The electrostatic sheet switch 30 has a sheet main body portion 31, an extension portion 35, and a contact portion 38. The sheet main body portion 31 is formed in a longitudinal shape corresponding to the shape of the input plane 60 and attached to the attachment region 22a provided to the back surface 21 of the ornament main body portion 20a. The sheet main body portion 31 is provided with a plurality of detection areas 32a through 32d. Each of the detection areas 32a through 32d is so-called a capacitance type switch and detects proximity and contact of an operation body, such as a finger, from a change in capacitance stored between the operation body and the self. As is shown in FIG. 5, when the sheet main body portion 31 is attached to the ornament main body portion 20a, the detection areas 32a through 32d are installed in the back surface direction BD of the switch plane portions 61 through 64 (see FIG. 2), respectively. Owing to this configuration, the respective detection areas 32a through 32d detect inputs of operations on the corresponding switch plane portions 61 through 64.

The extension portion 35 shown in FIG. 4 extends along the horizontal direction HD crossing the longitudinal direction from one of two sides of the sheet main body portion 31 along the longitudinal direction whichever is the more distant from the display screen 80 (see FIG. 1). The extension portion 35 is provided to the sheet main body portion 31 in a center part in the longitudinal direction. As is shown in FIG. 7, a tip end 36 in the extending direction of the extension portion 35 extending from the sheet main body portion 31 comes around to the back surface direction BD of the circuit board 50, which is an opposite side to the sheet main body portion 31, with the circuit board 50 in between.

The contact portion 38 shown in FIGS. 4 and 7 is formed at the tip end 36 of the extension portion 35 and allows one ends of respective wires 33a through 33d to be exposed to the outside. The wires 33a through 33d are connected to the detection areas 32a through 32d, respectively, and extend toward the contact portion 38 from the detection areas 32a through 32d, respectively. The contact portion 38 is connected to the connector 54 mounted on the rear surface 52 of the circuit board 50.

The holding portion 42 shown in FIG. 6 is provided to one of four sides of the escutcheon 40 along the vertical direction VD and in closest proximity to the driver seat. The holding portion 42 is provided with a plurality of locking holes 43 and 44, a plurality of fitting holes 45 through 48, and a slit 49.

The locking holes 43 and 44 are provided to the holding portion 42 in both end portions in the longitudinal direction so as to correspond to the locations of the locking claws 23 and 24, respectively. The locking holes 43 and 44 are provided with concave portions engaged, respectively, with the convex portions 23a and 24a provided to the locking claws 23 and 24, respectively. This configuration allows the respective locking holes 43 and 44 to lock the locking claws 23 and 24 inserted into the locking holes 43 and 44, respectively. The holding portion 42 holds the ornament 20 due to the cooperation of the locking holes 43 and 44 with the locking claws 23 and 24, respectively, as above.

The fitting holes 45 through 48 are through-holes provided to the holding portion 42 so as to correspond, respectively, to the locations of the ribs 25 through 28 (see FIG. 3 for the ribs 25 and 27), respectively. The respective fitting holes 45 through 48 are shaped like a long hole extending along the vertical direction VD. The ribs 25 through 28 are inserted into the fitting holes 45 through 48, respectively. By externally fitting the fitting holes 45 through 48 to the ribs 25 through 28, respectively, in this manner, a relative position of the ornament 20 with respect to the escutcheon 40 is regulated.

The slit 49 is a through-hole provided to the holding portion 42 in one of the two edge portions along the longitudinal direction whichever is the more distant from the opening 41. The slit 49 is located in a center part of the holding portion 42 in the vertical direction VD and on the outer peripheral side of the circuit board 50 (see FIG. 7) held by the escutcheon 40. An internal dimension of the slit 49 in the vertical direction VD is greater than a width of the extension portion 35. In addition, a width of the slit 49 in the horizontal direction HD is greater than a thickness of the extension portion 35. As is shown in FIG. 7, the tip end 36 of the extension portion 35 passing through the slit 49 from the display direction SD to the back surface direction BD can come around to the side of the rear surface 52 of the circuit board 50 from the outer peripheral side of the circuit board 50.

Steps to assemble the switch structure 10 of the configuration described above will be described in the following.

In an electrostatic sheet attachment step shown in FIG. 5, the electrostatic sheet switch 30 is attached to the back surface 21 of the ornament 20 from the back surface direction BD. The electrostatic sheet switch 30 is held in the attachment region 22a (see FIG. 3) in the back surface 21 of the ornament 20 with a double-sided adhesive tape or the like. As is shown in FIG. 3, the plurality of locking claws 23 and 24 and the plurality of ribs 25 through 28 are provided to stand in the enclosure region 22b that lies along the attachment region 22a and faces the attachment region 22a. This configuration allows a worker to bring the electrostatic sheet switch 30 in close proximity to the attachment region 22a along any one of the respective locking claws 23 and 24 and the respective ribs 25 through 28. A guiding function to guide the electrostatic sheet switch 30 to the proper attachment region 22a is exerted in this manner by the elements 23 through 28. The worker can thus attach the electrostatic sheet switch 30 at an exact position in the attachment region 22a.

In an ornament attachment step following the electrostatic sheet attachment step above, as is shown in FIG. 6, the ornament 20 is attached to the holding portion 42 from the display direction SD. The extension portion 35 of the electrostatic sheet switch 30 attached to the ornament 20 is inserted into the slit 49 from the tip end 36 as shown in FIG. 7. The tip end 36 passing through the slit 49 extends toward the rear surface 52 of the circuit board 50. Also, as is shown in FIG. 6, the locking claws 23 and 24 are inserted into the locking holes 43 and 44, respectively, and the ribs 25 through 28 are inserted into the fitting holes 45 through 48, respectively. Consequently, by externally fitting the fitting holes 45 through 48 to the ribs 25 through 28 (see FIG. 3 for the ribs 25 and 27), respectively, a relative position of the ornament 20 with respect to the escutcheon 40 is regulated. In addition, by locking the locking claws 23 and 24 in the locking holes 43 and 44, respectively, the ornament 20 is held by the holding portion 42.

In a connector connection step following the ornament attachment step above, as is shown in FIG. 7, the contact portion 38 is connected to the connector 54 in the back surface direction BD of the circuit board 50. The tip end 36 of the extension portion 35 is inserted into the connector 54 along the plate surface direction of the circuit board 50 and the horizontal direction HD from the side of the slit 49 toward the liquid crystal display instrument 81. Consequently, the respective detection areas 32a through 32d (see FIG. 4) are electrically connected to the control circuit of the navigation device 100 (see FIG. 1) provided to the circuit board 50.

In the present embodiment described above, because the ornament 20 provided with the input plane 60 is a separate body from the escutcheon 40, the ornament 20 can be smaller and of a simpler shape than the escutcheon 40. As has been described, by providing the input plane 60 to the ornament 20, working to add decoration, such as the decorative plated portion 66, to the input plane 60 can be easier. Consequently, a degree of freedom of the design of the input plane 60 can be increased and hence designability of the input plane 60 can be improved.

In addition, because the input plane 60 is provided to the ornament 20 which is a separate body from the escutcheon 40, the electrostatic sheet switch 30 is attached to the ornament 20. The ornament 20 is smaller and of a simpler shape than the escutcheon 40. Hence, a work to attach the electrostatic sheet switch 30 to the ornament 20 can be easier than a work to attach the electrostatic sheet switch 30 to the escutcheon 40. Consequently, workability in the electrostatic sheet attachment step can be improved.

According to the configuration to provide the input plane 60 to the ornament 20 which is a separate body from the escutcheon 40 as described above, not only the designability of the input plane 60 but also attachment workability of the electrostatic sheet switch 30 can be improved.

In addition, according to the present embodiment, by extending the extension portion 35 from the sheet main body portion 31, the tip end 36 of the extension portion 35 can be located on the side of the rear surface 52 of the circuit board 50. Accordingly, the worker can perform a work to connect the contact portion 38 and the connector 54 on the side of the back surface 52 of the circuit board 50 where the worker can readily make a visual confirmation. Hence, high workability can be ensured for the work to connect the contact portion 38 and the connector 54.

Further, electronic parts mounted on the rear surface 52 of the circuit board 50 tend to be fewer than electronic parts mounted on the counter surface 51 of the circuit board 50. Hence, by achieving the mounting of the connector 54 on the rear surface 52, a mounting area of the board can be effectively used. In addition, owing to the configuration to bring the tip end 36 around from the outer peripheral side of the circuit board 50, the through-hole to pass the tip end 36 can be omitted in the circuit board 50. Hence, the mounting area of the board can be secured in a more reliable manner.

The extension portion 35 of the electrostatic sheet switch 30 in the present embodiment extends in a direction crossing the vertical direction VD in which the respective detection areas 32a through 32d are aligned. When configured in this manner, it is easier to lay out the respective wires 33a through 33d connected to the contact portion 38 from the detection areas 32a through 32d, respectively. Hence, for example, a wire connected from one detection area to the contact portion 38 seldom narrows the areas of the other detection areas. When the areas of the respective detection areas 32a through 32d are secured more easily in this manner, limitations can be eased as to shapes of the respective switch surface portions 61 through 64, inputs to which are detected by the detection areas 32a through 32d, respectively. Accordingly, because a degree of freedom in shape of the switch surface portions 61 through 64 can be ensured, designability of the input plane 60 can be improved further.

Further, according to the present embodiment, the respective locking claws 23 and 24 and the respective ribs 25 through 28 exert a guiding function to guide the electrostatic sheet switch 30 to a proper attachment position in the electrostatic sheet attachment step. As has been described, owing to the locking claws 23 and 24 and the ribs 25 through 28 that not only exert a capability involved in holding the ornament 20 but also exert the guiding function, workability in the electrostatic sheet attachment step can be further improved while suppressing an increase in complexity of the switch structure 10.

In the present embodiment, the ornament 20 corresponds to the input panel, the locking claws 23 and 24 correspond to the locking claw portions, the ribs 25 through 28 correspond to extended wall portions, the electrostatic sheet switch 30 corresponds to the detector, the sheet main body portion 31 corresponds to the detection main body portion, the escutcheon 40 corresponds to the frame body, the connector 54 corresponds to the board connector, and the navigation device 100 corresponds to the electronic device.

### Other Embodiments

While one embodiment of the present disclosure has been described, the embodiment is not to be construed as limiting the invention thereto and the present disclosure can be implemented in various embodiments and combinations thereof within the scope and sprit of the present disclosure.

In the embodiment above, the switch structure 10 is provided to a portion adjacent to the display screen 80 in the horizontal direction HD. However, the position at which to provide the switch structure 10 can be changed as needed. For example, the switch structure 10 may be provided on a lower side of the display screen in the vertical direction. Further, it may be configured in such a manner that a plurality of switch structures are provided to the electronic device.

The plurality of switch plane portions 61 through 64 are arrayed in the input plane 60 in the embodiment above. However, an operation plane, via which a tracing operation by an operation body, such as a finger, is inputted and which is furnished with a function of a pointing device, may be provided instead of the plurality of switch plane portions or together with the plurality of switch plane portions. Further, the input plane 60 is not necessarily of a flat shape as in the embodiment above and can be formed in three dimensions.

In the embodiment above, the contact portion 38 of the electrostatic sheet switch 30 is connected to the connector 54 mounted on the rear surface 52 of the circuit board 50. In a configuration in which the contact portion is connected to the connector on the rear surface side in this manner, the extension portion may pass through a through-hole provided to the circuit board instead of the one provided on the outer peripheral side of the circuit board. Alternatively, the connector on the board side to be connected to the contact portion may be mounted on the counter surface of the circuit board.

The extension portion 35 of the electrostatic sheet switch 30 of the embodiment above extends in the horizontal direction HD crossing the longitudinal direction of the sheet main body portion 31. It should be appreciated, however, that the configuration of the extension portion 35 can be changed as needed. For example, the extension portion may extend from one end of the sheet main body portion in the longitudinal direction as long as the wiring does not interfere with formation of the detection area. Further, the extension portion may extend from more than one point of the sheet main body portion.

In the embodiment above, the respective locking claws 23 and 24 and the respective ribs 25 through 28 are installed and shaped in such a manner that these elements can exert the guiding function in the electrostatic sheet attachment step. It should be appreciated, however, that the locking claws and the ribs may not necessarily be configured so as to exert the guiding function. Further, the respective ribs may be omitted. Furthermore, fastening with screws or the like may be adopted instead of the locking claws and the locking holes described above as the configuration to hold the ornament in the holding portion and fix the former to the latter.

The embodiment above has described an example where the present disclosure is applied to the switch structure 10 of the navigation device 100 equipped to a vehicle and providing a guidance of a route to the destination. It should be appreciated, however, that a range of application of the present disclosure is not limited to the switch structure of the navigation device as described above. For example, the present disclosure is applicable to a switch structure provided to various types of electronic devices including a display screen and a frame body enclosing the display screen, such as a portable navigation device and a vehicle audio unit.

What is claimed is:

1. A switch structure provided to an electronic device including a display screen displaying an image and a frame-shaped frame body enclosing the display screen, the switch structure comprising:
an input panel formed separately from the frame body, installed along an outer edge of the display screen, and having an input plane via which an operation on the electronic device is inputted and a back surface on an opposite side of the input plane;
a detector attached to the back surface of the input panel and detecting an input to the input plane; and
a holding portion formed of the frame body and holding the input panel.

2. The switch structure according to claim 1, wherein
the switch structure is provided to the electronic device including a circuit board located on an opposite side to the input panel with the detector in between, and
the detector includes,
a detection main body attached to the back surface,
an extension portion extending from the detection main body portion so that a tip end in an extension direction comes around to an opposite side to the detection main body portion with the circuit board in between, and
a contact portion formed at the tip end of the extension portion and connected to a board connector mounted on a rear surface of the circuit board on an opposite side to a counter surface facing the detection main body.

3. The switch structure according to claim 2, wherein
the input plane is formed in a longitudinal shape lying along the outer edge of the display screen,
the detection main body portion has a longitudinal shape corresponding to the shape of the input plane, and
the extension portion extends in a direction crossing a longitudinal direction of the detection main body.

4. The switch structure according to claim 2, wherein
the tip end of the extension portion comes around on a side of the rear surface of the circuit board from an outer peripheral side of the circuit board.

5. The switch structure according to claim 1, wherein
the input panel has a locking claw portion provided to stand toward the holding portion in a region facing an outer edge of the detector; and
the holding portion is provided with a locking hole that holds the input panel by locking with the locking claw portion.

6. The switch structure according to claim 1, wherein
the input panel has an extended wall portion extending along an outer edge of the detector in the back surface, and
the holding portion is provided with a fitting hole that regulates a relative position of the input panel with respect to the frame body by fitting to the extended wall portion.
